(19) United States
(12) Patent Application Publication
(10) Pub. No.: US 2015/0220198 A1
(43) Pub. Date: Aug. 6, 2015

(54) DISPLAY DEVICE INCLUDING STYLUS PEN AND IMAGE INFORMATION DISPLAYING METHOD USING THE SAME

(71) Applicant: SAMSUNG ELECTRO-MECHANICS CO., LTD., Suwon-Si (KR)

(72) Inventors: Dong Sik Yoo, Suwon-Si (KR); Peter Jean Woo Lim, Suwon-Si (KR); Hee Bum Lee, Suwon-Si (KR)

(73) Assignee: SAMSUNG ELECTRO-MECHANICS CO., LTD., Suwon-Si (KR)

(21) Appl. No.: 14/538,788

(22) Filed: Nov. 11, 2014

(30) Foreign Application Priority Data
Feb. 4, 2014 (KR) 10-2014-0012676

(51) Int. Cl. G06F 3/041; G06F 3/0488; G06F 3/0484; G06F 3/0354

(52) U.S. Cl. CPC G06F 3/0414; G06F 3/03545; G06F 3/04883; G06F 3/04847

(57) ABSTRACT

Disclosed herein are a display device including a stylus pen including: a touch sensor; and a stylus pen detecting a pressure generated due to a touch on the touch sensor and generating a driving signal corresponding to the pressure and applying the generated driving signal to the touch sensor, and and an image information displaying method using the same.

### CROSS REFERENCE TO RELATED APPLICATION

This application claims the benefit of Korean Patent Application No. 10-2014-0012676, filed on Feb. 4, 2014, entitled “Display Device Including Stylus Pen And Image Information Displaying Method Using The Same” which is hereby incorporated by reference in its entirety into this application.

### BACKGROUND OF THE INVENTION

1. Technical Field

The present invention relates to a display device including a stylus pen and an image information displaying method using the same.

2. Description of the Related Art

Recently, a touch sensor which directly detects a touched position of a user's hand or an object to input/out data at the same position so as to remarkably reduce a volume of electronic devices and diversify functions thereof has been prevalently used.

Generally, the touch sensor inputs data using a user's finger, but recently, as in Patent Document, the following Korean Patent No. 10-0950946, the touch sensor includes a pen-shaped stylus pen as a data auxiliary input means and inputs data using the stylus pen.

The utilization of the stylus pen which may input data more elaborately than the user's hand has been increased.

### RELATED ART DOCUMENT

### Patent Document

(Patent Document 1) KR10-0950946 B

### SUMMARY OF THE INVENTION

The present invention has been made in an effort to provide a display device including a stylus pen capable of controlling a thickness of a line of image information displayed depending on a change in a sensing range of a touch sensor in response to a writing pressure and an image information displaying method using the same.

According to a preferred embodiment of the present invention, there is provided a display device including a stylus pen including: a touch sensor; and a stylus pen detecting a pressure generated due to a touch on the touch sensor and generating a driving signal corresponding to the pressure and applying the generated driving signal to the touch sensor.

The stylus pen may convert the pressure generated due to the touch on the touch sensor into an electrical signal and generate the driving signal corresponding to the electrical signal.

The stylus pen may amplify and output the generated driving signal with a predetermined gain.

The display device may further include: a controller detecting a change in a sensing range of the touch sensor by the driving signal applied to the touch sensor.

The controller may control each of the plurality of pixels of the touch sensor so that image information is displayed in response to the change in the detected sensing range.

The image information may be configured of any one of a handwritten character, a handwritten menu, a picture, a photograph, a chart, and a character.

The stylus pen may include: a pressure sensor sensing the pressure by the touch on the touch sensor; a control unit outputting a control signal corresponding to an electrical signal generated from the pressure sensor; a driving unit controlled by the control unit to generate and output a driving signal corresponding to the control signal; and an amplification unit receiving and amplifying the driving signal.

The control unit may control the driving unit by the control signal so as to control the sensing range of the touch sensor in response to the amplified driving signal.

The touch sensor may include: a plurality of electrode patterns receiving the driving signal from the stylus pen; and a controller performing a control to detect the change in the sensing range of the touch sensor in response to the driving signal received through the electrode pattern and to control a thickness of a line depending on the change in the sensing range to display the image information.

According to a preferred embodiment of the present invention, there is provided an image information display method including: touching a stylus pen on a touch sensor; generating, by the stylus pen, a driving signal in response to a pressure generated due to the touch; and applying the driving signal to the touch sensor.

The generating of the driving signal may include: generating and outputting, by a pressure sensor sensing the pressure, an electrical signal corresponding to the pressure; receiving, by a control unit, the electrical signal to output a control signal for controlling a thickness of a line of the displayed image information corresponding to the electrical signal; and generating and outputting, by a driving unit controlled by the control signal, the driving signal corresponding to the electrical signal.

The image information displaying method may further include: after the generating and outputting of the driving signal, amplifying, by an amplification unit receiving the driving signal, amplifying the driving signal.

The image information displaying method may further include: after the applying of the driving signal to the touch sensor, detecting, by the touch sensor, the sensing range changed corresponding to the driving signal; and controlling, by the touch sensor, a thickness of a line depending on the change in the sensing range to display image information.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating a display device according to a preferred embodiment of the present invention;

FIG. 2 is a cross-sectional view of the display device taken along the line I-I′ of FIG. 1;

FIG. 3 is a plan view of the touch sensor of FIG. 1;

FIG. 4 is a block diagram of an electrode pattern and a controller of FIG. 1;

FIG. 5 is a block diagram of the controller of FIG. 4;

FIG. 6 is a block diagram of the stylus pen of FIG. 1;

FIG. 7 is a flow chart of an image information display method using the stylus pen of FIG. 1;

FIG. 8 is a diagram illustrating that a driving signal of a driving unit of the stylus pen of FIG. 1 is applied to a touch sensor; and

FIG. 9 is a perspective view illustrating a change in a sensing range of the touch sensor in response to a writing pressure of a stylus pen of FIG. 1.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, a touch sensor according to preferred embodiments of the present invention will be described in detail with reference to the attached drawings.

FIG. 1 is a diagram illustrating a display device according to a preferred embodiment of the present invention. As illustrated in FIG. 1, the display device according to the preferred embodiment of the present invention includes a stylus pen 10 and an electronic device 100.

The stylus pen 10 is formed in a pen shape having a predetermined length and has a structure in which a tip T protrudes from an end of a body of the stylus pen and the detailed description thereof will be described below.

The electronic device 100 may understand a touched position of the stylus pen 10. That is, when the stylus pen 10 approaches or touches a touch sensor 101 of the electronic device 100, the touch sensor 101 senses the position.

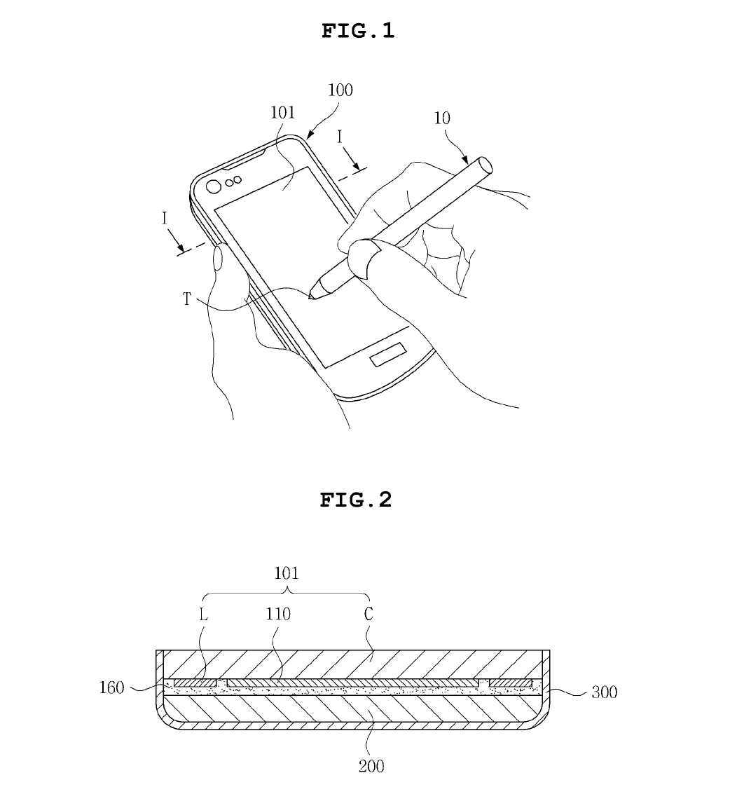

FIG. 2 is a cross-sectional view of the display device taken along the line I-I′ of FIG. 1. As illustrated in FIGS. 1 and 2, the electronic device 100 illustrates a portable terminal which includes a touch sensor 101 and a display unit 200 bonded to one surface of the touch sensor 101 by an adhesive layer 160. Further, the electronic device 100 may further include a case 300 which is formed to enclose the electronic device 100.

The touch sensor 101 includes a window substrate C, an electrode pattern 110 which is formed on a rear surface of the window substrate C, and an electrode wiring L which is electrically connected with the electrode pattern 110.

Here, a type of the touch sensor may be classified into a resistive type, a capacitive type, an electro-magnetic type, a surface acoustic wave (SAW) type, and an infrared type.

The window substrate C is disposed at an outermost side of the touch sensor 101 and receives a touch of a user and is made of tempered glass to serve as a protective layer. Further, the rear surface of the window substrate C may be formed with the electrode pattern 110, and therefore the rear surface of the window substrate C may suffer from high frequency treatment, primer treatment, or the like to form a surface treatment layer (not illustrated) so as to improve an adhesion between the window substrate C and the electrode pattern 110.

The electrode wiring 110 generates a signal by a touch input unit to allow a controller 120 to serve to recognize touched cooperates.

Further, the electrode patterns 140 may be formed in a mesh pattern using copper (Cu), aluminum (Al), gold (Au), silver (Ag), titanium (Ti), palladium (Pd), chromium (Cr), or a combination thereof

Meanwhile, the electrode pattern 110 may also be made of metal silver formed by exposing/developing a silver salt emulsion layer, metal oxides such as an indium thin oxide (ITO), or the like, a conductive polymer such as PEDOT/PSS, or the like, having excellent flexibility and a simple coating process.

Further, the electrode pattern 110 may be formed by continuously arranging at least one unit pattern (not illustrated). Here, the unit pattern (not illustrated) may selectively have a quadrangular shape, a triangular shape, a diamond shape, and other various shapes.

Further, the electrode pattern 110 may be formed of a single layer (bar type, tooth type, and the like) or a tow layers structure (bridge type or grid type).

Further, the protective layer (not illustrated) made of an optical clear adhesive (OCA) may be formed on the electrode pattern 110 to prevent the electrode pattern 110 to be physically or chemically damaged.

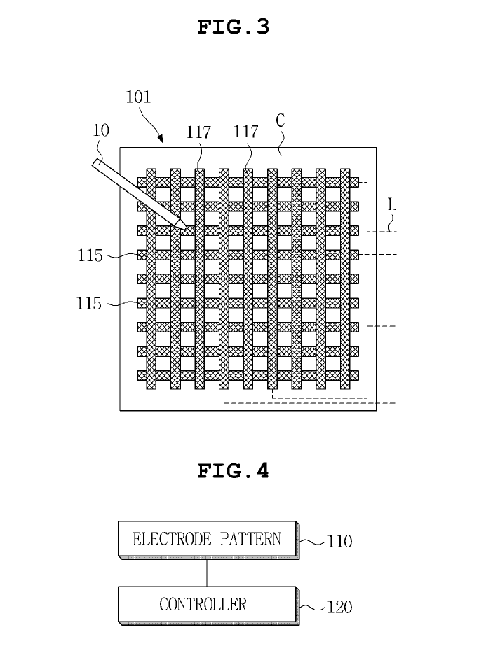

FIG. 3 is a plan view of the touch sensor of FIG. 1 and as illustrated in FIG. 3, the electrode pattern 110 is disposed so that a plurality of first electrode patterns 115 and second electrode patterns 117 are orthogonal to each other. For example, the electrode pattern 110 may include the plurality of first electrode patterns 115 which are formed in parallel with each other in an X-axis direction and the plurality of second electrode patterns 117 which are formed in parallel with each other in a Y-axis direction in which the plurality of second electrode patterns 117 intersect the plurality of first electrode patterns 115.

One end of the electrode pattern 110 is provided with an electrode wiring L to receive an electrical signal from the electrode pattern 110. In this case, the electrode wiring L may be formed by screen printing, gravure printing, inkjet printing, or the like. In addition, an example of a material of the electrode wiring L may include silver (Ag) paste or organic silver that has excellent electrical conductivity, but is not limited thereto, and therefore as the material of the electrode wiring L, conductive polymer, carbonblack (including CNT), metal oxide, metals, or the like may be used.

The insulating layer 160 serves to bond the electrode pattern 110 and the display unit 200 to the window substrate C and may be made of a transparent material so as not to hinder a user from recognizing an image output from the display unit 20, for example, an optical clear adhesive (OCA).

The display unit 200 is a display device which visually outputs data on a screen and may mainly be a cathode ray tube (CRT), a liquid crystal display (LCD), a plasma display panel (PDP), a light emitting diode (LED), and an organic light emitting diode (OLED), but is not necessarily limited thereto.

FIG. 4 is a block diagram of an electrode pattern and a controller of FIG. 1.

As illustrated in FIG. 4, the touch sensor 101 may further include a controller 120 which is electrically connected to the electrode pattern 110.

The controller 120 senses a change in mutual capacitance between the first and second electrode patterns 115 and 117 due to a touch input on the touch sensor 101 to detect coordinates of the touch input.

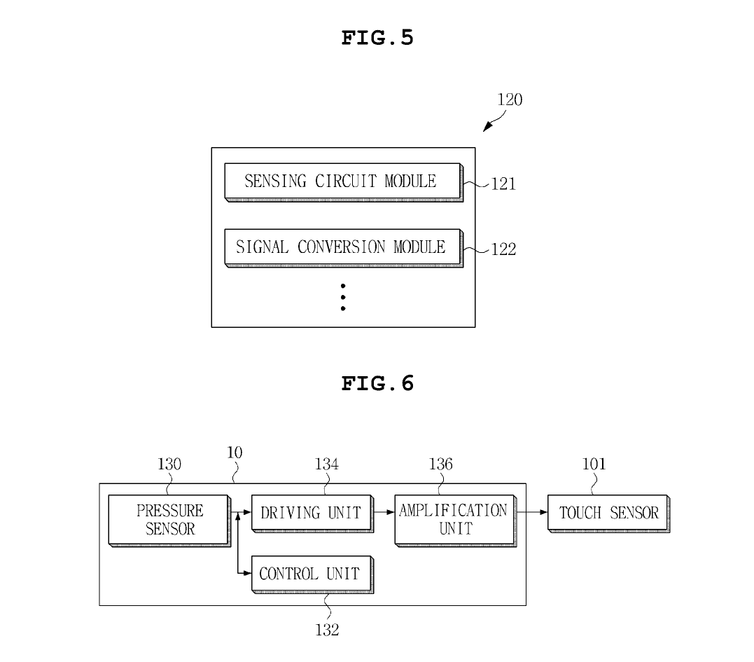

FIG. 5 is a block diagram of the controller of FIG. 4. As illustrated in FIG. 5, the controller 120 may include a sensing circuit module 121, a signal conversion module 122, and the like.

The sensing circuit module 121 senses the change in mutual capacitance between the first and second electrode patterns 115 and 117 due to the touch input and generates an analog signal (voltage form) corresponding thereto.

The signal conversion module 122 converts the analog signal (voltage form) into a digital signal. Here, the controller 120 uses the digital signal to allow the touch sensor 101 to determine the coordinates, and the like of the touch input.

Hereinafter, a configuration of the stylus pen 10 according to the preferred embodiment of the present invention will be described in detail.

FIG. 6 is a block diagram illustrating components of the stylus pen of FIG. 1. As illustrated in FIG. 6, the stylus pen 10 according to the preferred embodiment is a tool which may perform various inputs to the electronic device 100, instead of the user's hand and includes a pressure sensor 130, a control unit 132, a driving unit 134, and an amplifier 136. Further, the stylus pen 10 may be classified into an active type stylus pen or a passive type stylus pen depending on whether a battery is present.

The pressure sensor 130 generates an electrical signal depending on a pressure which is applied to the tip T protruding from the end of the body of the stylus pen 10. For example, the pressure sensor 130 generates the electrical signal in response to the pressure applied to the tip T by a wring operation of the user. To this end, the tip T is connected to the pressure sensor 130 to be able to transfer the pressure generated from the tip T to the pressure sensor 130.

The control unit 132 controls the driving unit 134. That is, the control unit 132 may control the driving signal of the driving unit 134 in response to the electrical signal generated from the pressure sensor 130. To this end, the control unit 132 generates the control signal corresponding to the electrical signal generated from the pressure sensor 130 by referring to a separate lookup table, Equation, or the like and outputs the generated control signal to the driving unit 134 to be able to control the driving signal of the driving unit 134.

The driving unit 134 generates and outputs the driving signal corresponding to the control signal input from the control unit 132. The amplification unit 136 amplifies and outputs a weak driving signal of the driving unit 134 with a predetermined gain. Here, an amplification factor of the amplification unit 136 may be controlled by changing a variable resistor of an internal circuit of the stylus pen 10 Further, the amplification unit may be configured of a non-inversion amplifier which keeps a phase of the driving signal as it is and amplifies and outputs only a level thereof

Hereinafter, an image information display method using the stylus pen 10 according to the preferred embodiment of the present invention will be described in detail.

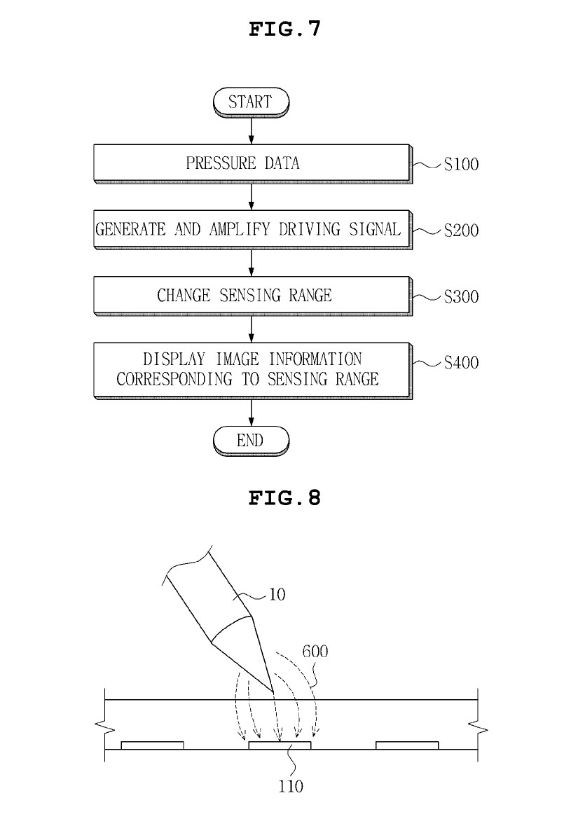

FIG. 7 is a flow chart of an image information display method using the stylus pen of FIG. 1.

The stylus pen 10 moving by the operation of the user touches the touch sensor 101 of the electronic device 100 in the state in which the stylus pen 10 is spaced apart from the electronic device 100, that is, a hovering state. For example, when the user of the electronic device 100 intends to display the image information on the touch sensor 101, the stylus pen 10 touches the touch sensor 101 of the electronic device 100. Here, the image information is configured of handwritten characters, handwritten menus, pictures, photographs, charts, characters, and the like.

Further, when the stylus pen 10 touches the touch sensor 10 and then the pressure is applied, the pressure sensor 130 generates and outputs the electrical signal in response to the pressure sensed by the tip T protruding from the end of the body of the stylus pen 10.

To be continued, the control unit 132 generates and outputs a pressure data which is a control signal corresponding to the electrical signal generated from the pressure sensor 130 by referring to separate lookup table, Equation, or the like (S100).

Here, the control unit 132 may output the pressure data which is the control signal to the driving unit 134 to control the driving signal of the driving unit 134. Further, the control unit 132 may be a micro controller unit (MCU).

Further, the driving unit 134 generates and outputs the driving signal corresponding to the pressure data which is the control signal input from the control unit 132. Next, the amplification unit 136 amplifies the weak driving signal of the driving unit 134 which is input from the driving unit 134 (S200).

FIG. 8 is a diagram illustrating that the driving signal of the driving unit of the stylus pen of FIG. 1 is applied to the touch sensor of the electronic device. As illustrated in FIG. 8, the stylus pen 10 applies the driving signal of the driving unit 134 amplified by the amplification unit 136 to the touch sensor 101 of the electronic device 100 to detect the writing pressure of the stylus pen 10 in the electronic device 100.

That is, the stylus pen 10 applies the driving signal of the driving 134 amplified by the amplification unit 136 to the touch sensor 101 to change the sensing range of the touch sensor 101 depending on the driving signal of the driving unit 134 (S300).

Here, the writing pressure is a pressure applied to the tip T of the stylus pen 10. The writing pressure of the stylus pen 10 is an important factor to users wishing to a minute touch or users wishing to draw a picture or directly use handwriting, and the wiring pressure makes a picture like a picture or imparts personality to handwriting to implement an individual signature.

Further, controlling of the sensing range of the touch sensor 101 in response to the change in strength of the driving signal of the driving unit 134 may be different depending on the type of the stylus pen 10. For example, an electromagnetic induction type needs to control a magnetic field signal and a capacitance type needs to control an electric field signal.

To be continued, the change in the sensing range of the touch sensor 101 may be directly applied in the form of the writing pressure and the image information is displayed on the touch sensor 101 by the thickness of the line corresponding to the changed sensing range.

Here, the sensing range of the touch sensor 101 is changed depending on the change in the electrical signal generated from the pressure sensor 130 and thus the thickness of the line displayed on the touch screen 101 may be controlled.

For example, the controller 120 senses the change in mutual capacitance between the first and second electrode patterns 115 and 117, that is, the change in the sensing range depending on the strength of the driving signal of the driving unit 134 applied from the stylus pen 10 to detect the coordinates of the touch input.

Next, the controller 120 controls each of the plurality of pixels of the touch sensor in response to the change in the detected sensing range to display the image information on the touch sensor 101 by the thickness of the line corresponding to the changed sensing range.

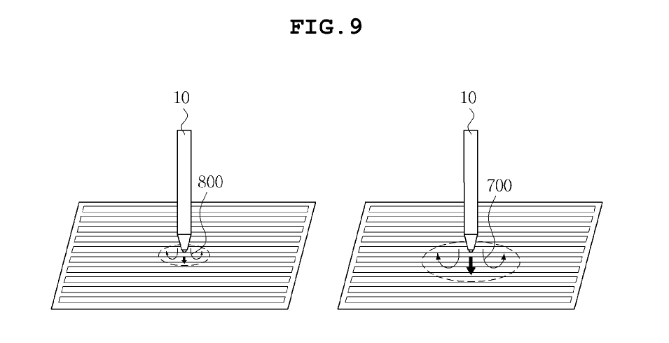

FIG. 9 is a perspective view illustrating a change in a sensing range of the touch sensor in response to a writing pressure of a stylus pen of FIG. 1. For example, as illustrated in FIG. 9, when the size of the electrical signal generated from the pressure sensor 130 is increased, the sensing range of the touch sensor 101 is also increased and thus the thickness of the displayed line is thick. Meanwhile, when the size of the electrical signal generated from the pressure sensor 130 is reduced, the sensing range of the touch sensor 101 is reduced and thus the thickness of the displayed line is thin.

As described above, the stylus pen according to the embodiment of the present invention includes the pressure sensor and the driving unit generated from the driving signal in response to the output signal of the pressure sensor to apply the driving signal generated from the driving unit to the touch signal, thereby controlling the driving signal of the touch sensor depending on the output signal of the pressure sensor.

The image information displaying method using the stylus pen according to the preferred embodiment of the present invention applies the driving signal generated from the driving unit of the stylus pen to the touch sensor to control the driving signal of the touch signal in response to the output signal of the pressure sensor, thereby changing the sensing range of the touch sensor. Therefore, the thickness of the line of the displayed image information may be controlled depending on the change in the sensing range of the touch sensor corresponding to the writing pressure of the stylus pen, without adding a separate component to the touch sensor to make the output signal of the pressure sensor into the writing pressure.

That is, to control the thickness of the line of the displayed image information, a method of additionally configuring a sensor to sense a separate pressure in the touch sensor and performing a separate software (S/W) processing process to match the writing pressure of the stylus pen with the display of the image information is complicated since the data of the writing pressure needs to be generated by receiving and calculating information depending on the stylus pen using a sensor sensing a pressure which is separately additionally configured and the thickness of the line of the displayed image information is controlled by performing the separate S/W processing using the data of the generated writing pressure.

As described above, the image information display method using the stylus pen according to the preferred embodiment of the present invention embeds the driving unit generating the driving signal in the stylus pen and thus the separate component need to be added in the touch sensor and the separate S/W processing is not required.

That is, the driving signal of the stylus pen is applied to the touch sensor to increase the sensing range of the touch sensor. Further, the increased sensing range may be directly reflected on the display of the image information and thus the thickness of the line of the displayed image information may be controlled depending on the change in the sensing range of the touch sensor.

According to the preferred embodiments of the present invention, the stylus pen includes the pressure sensor sensing the writing pressure of the stylus pen and the driving unit generating the driving signal corresponding to the output signal from the pressure sensor to apply the driving signal to the touch sensor, thereby controlling the thickness of the line of the image information displayed depending on the change in the sensing range of the touch sensor in response to the driving signal.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A display device including a stylus pen, comprising:
a touch sensor; and
a stylus pen detecting a pressure generated due to a touch on the touch sensor and generating a driving signal corresponding to the pressure and applying the generated driving signal to the touch sensor.

2. The display device as set forth in claim 1, wherein the stylus pen converts the pressure generated due to the touch on the touch sensor into an electrical signal and generates the driving signal corresponding to the electrical signal.

3. The display device as set forth in claim 1, wherein the stylus pen amplifies and outputs the generated driving signal with a predetermined gain.

4. The display device as set forth in claim 1, further comprising:
a controller detecting a change in a sensing range of the touch sensor by the driving signal applied to the touch sensor.

5. The display device as set forth in claim 4, wherein the controller controls each of the plurality of pixels of the touch sensor so that image information is displayed in response to the change in the detected sensing range.

6. The display device as set forth in claim 5, wherein the image information is configured of any one of a handwritten character, a handwritten menu, a picture, a photograph, a chart, and a character.

7. The display device as set forth in claim 1, wherein the stylus pen includes:
a pressure sensor sensing the pressure by the touch on the touch sensor;
a control unit outputting a control signal corresponding to an electrical signal generated from the pressure sensor;
a driving unit controlled by the control unit to generate and output a driving signal corresponding to the control signal; and
an amplification unit receiving and amplifying the driving signal.

8. The display device as set forth in claim 7, wherein the control unit controls the driving unit by the control signal so as to control the sensing range of the touch sensor in response to the amplified driving signal.

9. The display device as set forth in claim 1, wherein the touch sensor includes:
a plurality of electrode patterns receiving the driving signal from the stylus pen; and
a controller performing a control to detect the change in the sensing range of the touch sensor in response to the driving signal received through the electrode pattern and to control a thickness of a line depending on the change in the sensing range to display the image information.

10. An image information displaying method, comprising:
touching a stylus pen on a touch sensor;
generating, by the stylus pen, a driving signal in response to a pressure generated due to the touch; and
applying the driving signal to the touch sensor.

11. The image information displaying method as set forth in claim 10, wherein the generating of the driving signal includes:
generating and outputting, by a pressure sensor sensing the pressure, an electrical signal corresponding to the pressure;
receiving, by a control unit, the electrical signal to output a control signal for controlling a thickness of a line of the displayed image information corresponding to the electrical signal; and
generating and outputting, by a driving unit controlled by the control signal, the driving signal corresponding to the electrical signal.

12. The image information displaying method as set forth in claim 11, further comprising:
after the generating and outputting of the driving signal, amplifying, by an amplification unit receiving the driving signal, amplifying the driving signal.

13. The image information displaying method as set forth in claim 10, further comprising:
after the applying of the driving signal to the touch sensor, detecting, by the touch sensor, the sensing range changed corresponding to the driving signal; and
controlling, by the touch sensor, a thickness of a line depending on the change in the sensing range to display image information.
